(19) United States
(12) Patent Application Publication
(10) Pub. No.: US 2015/0119028 A1
(43) Pub. Date: Apr. 30, 2015

(54) Method, device and terminal for selecting public land mobile network

(71) Applicant: Na Zhang, Shenzhen (CN)

(72) Inventor: Na Zhang, Shenzhen (CN)

(73) Assignee: ZTE Corporation, Shenzhen, Guangdong (CN)

(21) Appl. No.: 14/404,164

(22) PCT Filed: Aug. 22, 2012
(86) PCT No.: PCT/CN2012/080465

§ 371 Date: Nov. 26, 2014

(30) Foreign Application Priority Data
May 28, 2012 (CN) 201210168998.7

(51) Int. Cl. H04W 48/18

(52) U.S. Cl. CPC H04W 48/18
USPC 455/434

(57) ABSTRACT

A method, device and terminal for selecting a Public Land Mobile Network (PLMN) are disclosed. The device includes a wireless access technology module for storing one or more wireless access technologies supported by the terminal and select a wireless access technology for accessing a PLMN, a list module for generating a PLMN list according to the wireless access technology selected by the wireless access technology module, and a network selecting module for searching and selecting a PLMN according to the PLMN list. The method includes determining a wireless access technology for accessing a PLMN; generating a PLMN list according to the wireless access technology; and, searching and selecting a PLMN according to the PLMN list. Through implementation of the disclosure, the problem that a wireless access technology expected by a user can not be implemented due to use of a network selecting method provided by a current 3GPP standard protocol can be better solved, and the user experience is enhanced.

### TECHNICAL FIELD

The disclosure relates to the technical field of communications, and more particularly to a method, device and terminal for selecting a Public Land Mobile Network (PLMN).

### BACKGROUND

With the development of wireless data service technology, new operators are constantly emerging, and established operators are also gradually exploring the international market; but each operator always establishes only a new generation communication network when entering an emerging market, and in this process, it is impossible to quickly achieve a 100% new network coverage for a specified area; these new and emerging operators often establish a communication network by themselves, and sign a roaming protocol with local service providers; thus, cooperation among these operators is continuously strengthened.

A network selecting technology is the key technology of User Equipment (UE), and a network selecting speed of the UE is the critical index to evaluate the performance of the UE. A network selecting method provided by a 3rd Generation Partnership Project (3GPP) standard protocol can not meet the requirement of users for quick network selection of the UE any more; the network selecting method provided by the 3GPP standard protocol is as follows:

No matter for automatic network selection or manual network selection, after being powered on, UE first attempts a Registered Public Land Mobile Network (RPLMN), if it is successful, there will be no following process, if it is not successful, the UE will generate a Public Land Mobile Network (PLMN) list; wherein the PLMN list is as follows:

(1) Home Public Land Mobile Network (HPLMN);

(2) User Controlled Public Land Mobile Network (UPLMN) (which is the PLMN in the User Controlled PLMN Selector with Access Technology recorded in the Universal Subscriber Identity Module (USIM) file in the UE; these PLMNs are arranged according to priority in the USIM);

(3) Operator Controlled Public Land Mobile Network (OPLMN) (which is the PLMN in the Operator Controlled PLMN Selector with Access Technology recorded in the USIM file in the UE, these PLMNs are arranged according to priority in the USIM);

(4) PLMNs with relatively good signal quality, which are arranged randomly;

(5) other PLMNs, which are arranged in descending order of signal quality;

the UE searches according to the above PLMN list one by one and attempts to register.

According to the 3GPP standard protocol, when the UE automatically selects a network, the Universal Mobile Telecommunications System (UMTS, also called 3GSM) and the Global System for Mobile Communications (GSM) are two different wireless access technologies; during selection of the PLMN, it is needed to indicate the preferential wireless access technology; if it is not indicated, the GSM/Enhanced Data Rate for GSM Evolution (EDGE) Radio Access Network (GERAN) is a default selection.

The above network selecting method at least has the following problems:

(1) the wireless access technology is stored in a Subscriber Identity Module (SIM) card of a user, and the SIM card can not be modified after being issued to the user, therefore a wireless access technology expected by the user can not be implemented; for example, the user hopes that 3G is the preferential technology, but the SIM card indicates that the preferential access technology is 2G; at this point, the network selecting method provided by the 3GPP standard protocol is still accessing a network by 2G, which causes poor user experience;

(2) it is unable to select a network or the speed of selecting a network is slow; especially a part of the new network operators allow only one wireless access technology at present, but for the network selecting method provided by the 3GPP standard protocol, other wireless access technologies may be the default technologies, thereby causing a long time for selecting a network and poor user experience;

(3) the current Forbidden Public Land Mobile Network (FPLMN) list can not differentiate the wireless access technologies; once a certain PLMN is added into an FPLMN list, all the wireless access technologies of the PLMN can not be used; for applications which have signed a roaming protocol with other wireless access technologies of the PLMN, the PLMN mechanism can not be used either, which causes poor user experience.

To sum up, it is urgent for those skilled in the field to present a new method for selecting a PLMN to solve the disadvantages of the network selecting method provided by the current 3GPP standard protocol.

### SUMMARY

For solving the problem that a wireless access technology expected by a user can not be implemented due to use of a network selecting method provided by a current 3GPP standard protocol, the disclosure provides a method, device and terminal for selecting a PLMN.

In an embodiment, the method for selecting a PLMN provided by the disclosure includes:

selecting a wireless access technology for accessing a PLMN;

generating a PLMN list according to the wireless access technology; and

searching and selecting a PLMN according to the PLMN list.

In an embodiment, the process of selecting a wireless access technology for accessing a PLMN in above embodiment includes:

detecting whether a user has set a wireless access technology; if the user has set a wireless access technology, then selecting the wireless access technology set by the user as the wireless access technology for accessing a PLMN; if the user has not set a wireless access technology, then detecting whether a terminal has registered with a PLMN successfully; and

if the terminal has registered with a PLMN, then selecting a wireless access technology when the terminal last registered with a PLMN successfully as the wireless access technology for accessing a PLMN; if a terminal has not registered to a PLMN, selecting a wireless access technology supported by the terminal as the wireless access technology for accessing a PLMN.

In an embodiment, the process of selecting a wireless access technology supported by the terminal as the wireless access technology for accessing a PLMN in above embodiment includes:

arranging one or more wireless access technologies supported by the terminal in order of GERAN, Universal Mobile Telecommunications system (UMTS) and Long Term Evolution (LTE) to generate a wireless access technology list; and

selecting a wireless access technology from the one or more wireless access technologies supported by the terminal in order according to the wireless access technology list as the wireless access technology for accessing a PLMN.

In an embodiment, the process of generating a PLMN list according to the wireless access technology in above embodiment includes:

detecting all the available PLMNs conforming to the wireless access technology; and

arranging all the detected available PLMNs according to a preset rule to generate a PLMN list.

In an embodiment, the preset rule in above embodiment is: arranging all the available PLMNs in order of RPLMN, HPLMN, UPLMN and OPLMN.

At the same time, a device is also provided for selecting a PLMN; in an embodiment, the device for selecting a PLMN provided by the disclosure includes a wireless access technology module, a list module and a network selecting module;

the wireless access technology module is connected with the list module, and is configured to detect and store a wireless access technology for accessing a PLMN which is supported by a terminal, and select a wireless access technology for accessing a PLMN and transmit the same to the list module;

the list module is connected with the network selecting module, and is configured to generate a PLMN list according to the wireless access technology selected by the wireless access technology module, and transmit the PLMN list to the network selecting module; and

the network selecting module is configured to search and select a PLMN according to the PLMN list.

In an embodiment, the wireless access technology module in above embodiment includes a first unit which is configured to store the wireless access technology selected by a user, a second unit which is configured to store the wireless access technology when a terminal last registered with a PLMN successfully, a third unit which is configured to store one or more wireless access technologies supported by a terminal, and a detecting unit;

the detecting unit is configured to detect whether the first unit stores a wireless access technology; if the first unit stores a wireless access technology, then the detecting unit selects the wireless access technology stored by the first unit as the wireless access technology for accessing a PLMN; if the first unit does not store a wireless access technology, the detecting unit detects whether the second unit stores a wireless access technology; if the second unit stores a wireless access technology, the detecting unit selects the wireless access technology stored by the second unit as the wireless access technology for accessing a PLMN; the detecting unit is further configured to, when both the first unit and the second unit do not store a wireless access technology, select a wireless access technology from the one or more wireless access technologies stored by the third unit as the wireless access technology for accessing a PLMN.

In an embodiment, the third unit in above embodiment includes a list subunit which is configured to arrange the one or more wireless access technologies stored by the third unit in order of GERAN, UMTS and LTE to generate a wireless access technology list; the detecting unit is further configured to select, according to the wireless access technology list, the one or more wireless access technologies supported by the terminal in order as the wireless access technology for accessing a PLMN.

In an embodiment, the list module in above embodiment is configured to detect all the available PLMNs conforming to the wireless access technology, and arrange all the detected available PLMNs according to a preset rule to generate a PLMN list.

In an embodiment, the preset rule in above embodiment is: arranging all the available PLMNs in order of RPLMN, HPLMN, UPLMN and OPLMN.

The disclosure also provides a terminal for selecting a PLMN to apply the device for selecting a PLMN provided by the disclosure; in an embodiment, the terminal for selecting a PLMN provided by the disclosure includes any device for selecting a PLMN in above embodiments; the terminal for selecting a PLMN uses the device for selecting a PLMN to search and select a PLMN.

In the device and terminal for selecting a PLMN provided by the disclosure, both the wireless access technology module and the list module may be configured by a user, so that the user can perform the optimum configuration as needed to implement quick network selection; since it requires to first determine a wireless access technology, the cooperated operator supporting only one wireless access technology can be selected as soon as possible under the wireless access technology supported by itself; the PLMN which is listed in an FPLMN list is no longer forbidden completely, it is listed as an FPLMN only under a certain wireless access technology, but it may be selected through other wireless access technologies; thus, through implementation of the disclosure, the problem that a wireless access technology expected by a user can not be implemented due to use of a network selecting method provided by a current 3GPP standard protocol can be better solved, and the user experience is enhanced.

### BRIEF DESCRIPTION OF THE DRAWINGS

FIG. 1 is a structure diagram of a terminal for selecting a PLMN provided by the disclosure;

FIG. 2 is a structure diagram of a device for selecting a PLMN provided by the disclosure;

FIG. 3 is a diagram of a wireless access technology module in a device for selecting a PLMN provided by the disclosure;

FIG. 4 is a flowchart of a method for selecting a PLMN provided by the disclosure;

FIG. 5 is a flowchart of determining a wireless access technology in a method for selecting a PLMN provided by the disclosure;

FIG. 6 is a flowchart of determining a wireless access technology list in a method for selecting a PLMN provided by the disclosure;

FIG. 7 is a flowchart of a network selecting method provided by a current 3GPP standard protocol; and

FIG. 8 is a flowchart of a specific implementation mode of a method for selecting a PLMN provided by the disclosure.

### DETAILED DESCRIPTION

The disclosure is further elaborated below through specific implementation modes and in combination with the accompanying drawings.

FIG. 1 is a structure diagram of a terminal for selecting a PLMN 11 provided by the disclosure.

It can be seen from FIG. 1 that in an implementation mode, the terminal for selecting a PLMN 11 provided by the disclosure includes a device for selecting a PLMN 12; the terminal for selecting a PLMN 11 uses the device for selecting a PLMN 12 to search and select a PLMN;

the terminal for selecting a PLMN 11 implements the following functions: the device for selecting a PLMN 12 acquires and stores a wireless access technology set by an owner of the terminal for selecting a PLMN 11, a wireless access technology when the terminal for selecting a PLMN 11 registered with a PLMN most recently, and a wireless access technology supported by the terminal for selecting a PLMN 11;

the device for selecting a PLMN 12 selects a wireless access technology as the wireless access technology when the terminal for selecting a PLMN 11 registers with a PLMN;

the device for selecting a PLMN 12 generates a PLMN list according to the selected wireless access technology;

the device for selecting a PLMN 12 searches and selects a PLMN according to the PLMN list.

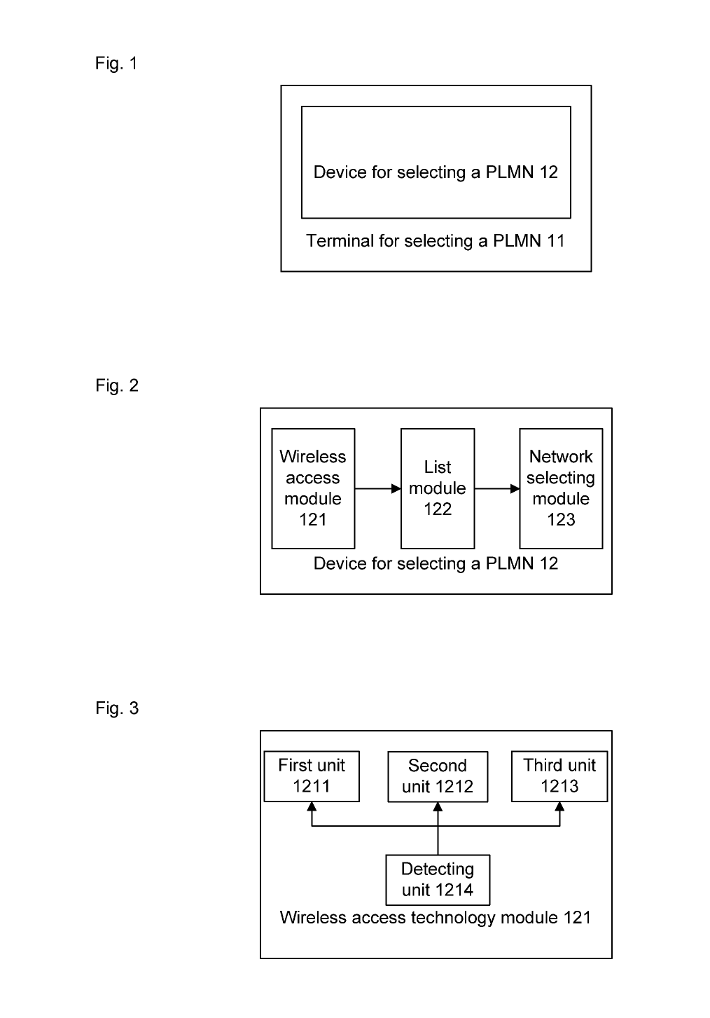

FIG. 2 is a structure diagram of the device for selecting a PLMN 12 in the terminal for selecting a PLMN 11 as shown in FIG. 1.

It can be seen from FIG. 2 that in an implementation mode, the device for selecting a PLMN 12 provided by the disclosure includes a wireless access technology module 121, a list module 122 and a network selecting module 123;

the wireless access technology module 121 is connected with the list module 122, and is configured to detect and store a wireless access technology for accessing a PLMN which is supported by the terminal for selecting a PLMN 11, and select a wireless access technology when accessing to a PLMN and transmit the selected wireless access technology to the list module 122;

the list module 122 is connected with the network selecting module 123, and is configured to generate a PLMN list according to the wireless access technology selected by the wireless access technology module 121, and transmit the PLMN list to the network selecting module 123; and

the network selecting module 123 is configured to search and select a PLMN according to the PLMN list.

FIG. 3 is a diagram of the wireless access technology module 121 in the device for selecting a PLMN 12 shown in FIG. 2.

It can be seen from FIG. 3 that in an implementation mode, the wireless access technology module 121 provided by the disclosure includes a first unit 1211, a second unit 1212, a third unit 1213 and a detecting unit 1214;

the first unit 1211 is configured to store the wireless access technology selected by a user of the terminal for selecting a PLMN 11;

the second unit 1212 is configured to store the wireless access technology when the terminal for selecting a PLMN 11 successfully registered with a PLMN most recently;

the third unit 1213 is configured to store all the other wireless access technologies supported by the terminal for selecting a PLMN 11 except the wireless access technologies stored by the first unit 1211 and the second unit 1212; and

the detecting unit 1214 is configured to detect whether the first unit 1211 stores a wireless access technology; if the first unit 1211 stores a wireless access technology, then the detecting unit 1214 selects the wireless access technology stored by the first unit 1211 as the wireless access technology for the terminal for selecting a PLMN 11 to access a PLMN; if the first unit 1211 does not store a wireless access technology, then the detecting unit 1214 detects whether the second unit 1212 stores a wireless access technology; if the second unit 1212 stores a wireless access technology, then the detecting unit 1214 selects the wireless access technology stored by the second unit 1212 as the wireless access technology for the terminal for selecting a PLMN 11 to access a PLMN; the detecting unit 1214 is further configured to, when both the first unit 1211 and the second unit 1212 do not store a wireless access technology, select the wireless access technology stored by the third unit 1213 as the wireless access technology for the terminal for selecting a PLMN 11 to access a PLMN.

In an embodiment, the third unit 1213 in above embodiment includes a list subunit which is configured to arrange the wireless access technologies stored by the third unit in order of GERAN, UMTS and LTE to generate a wireless access technology list; the detecting unit 1214 is further configured to select, according to the wireless access technology list generated by the list subunit, the wireless access technologies supported by the terminal for selecting a PLMN 11 in order as the wireless access technology for the terminal for selecting a PLMN 11 to access a PLMN.

In an embodiment, the list subunit in above embodiment is characterised in that the wireless access technology list is automatically generated and adjusted, and is adapted automatically with change of user settings or network environment; when the wireless access technologies in the first unit 1211 and the second unit 1212 are used, the wireless access technology in the third unit 1213 is released.

In an embodiment, the list module 122 in above embodiment is configured to detect all the available PLMNs conforming to the wireless access technology, and arrange all the detected available PLMNs according to a preset rule to generate a PLMN list.

In an embodiment, the preset rule in above embodiment is: arranging all the available PLMNs in order of RPLMN, HPLMN, OPLMN and UPLMN; the other PLMNs are arranged in order; when there are multiple other PLMNs, they are arranged in descending order of signal intensity; if there are multiple UPLMNs and OPLMNs, they are arranged according to priority; when there are multiple PLMNs with equivalent signal intensity, they are arranged according to priority.

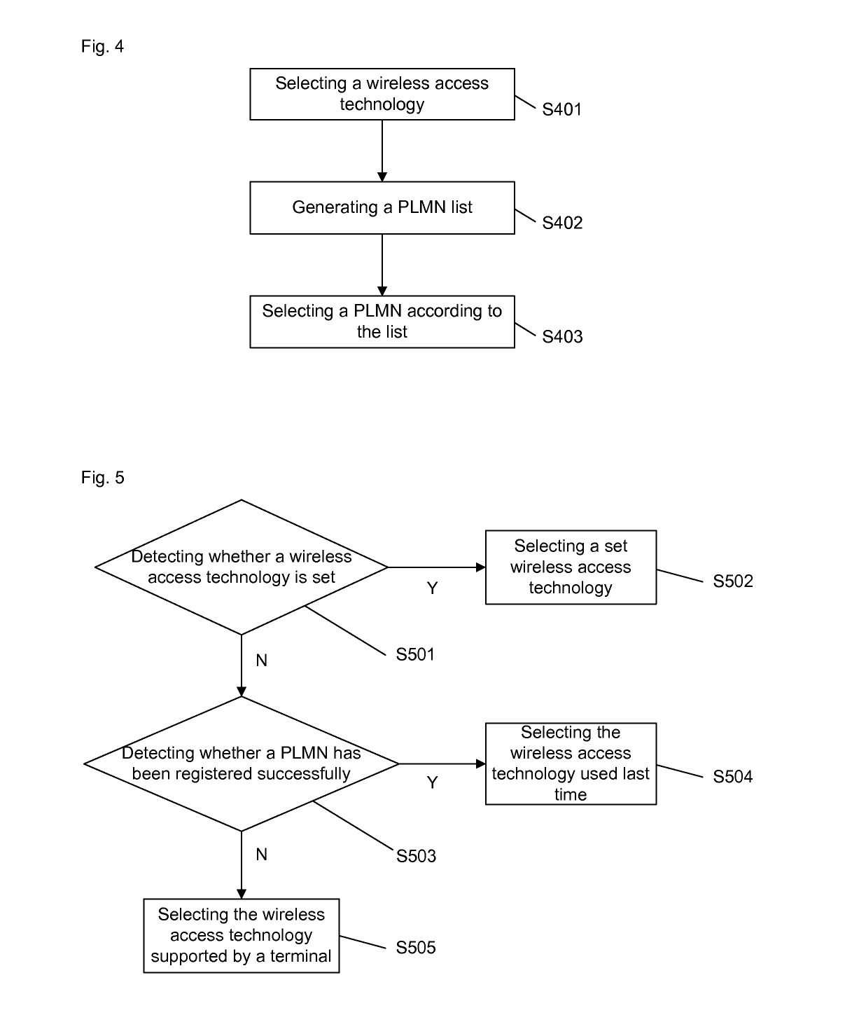

FIG. 4 is a flowchart of a method for selecting a PLMN by the terminal for selecting a PLMN 11 shown in FIG. 1.

It can be seen from FIG. 4 that a specific implementation mode of the method for selecting a PLMN provided by the disclosure includes the following steps:

S401: selecting a wireless access technology when accessing a PLMN;

S402: generating a PLMN list according to the wireless access technology; and

S403: searching and selecting a PLMN according to the PLMN list.

FIG. 5 is a flowchart of determining a wireless access technology in the method for selecting a PLMN shown in FIG. 4.

It can be seen from FIG. 5 that the process of determining a wireless access technology when accessing a PLMN in above implementation mode includes the following steps:

S501: detecting whether a user of the terminal for selecting a PLMN 11 has set a preferred wireless access technology for the terminal for selecting a PLMN 11 to access a PLMN; if a preferred wireless access technology has been set, executing S502; if not, executing S503;

S502: selecting the wireless access technology preset by the user of the terminal for selecting a PLMN 11 as the wireless access technology for accessing a PLMN;

S503: further detecting whether the terminal for selecting a PLMN 11 has registered with a PLMN successfully; if successfully, executing S504; if not, executing S505;

S504: selecting the wireless access technology when the terminal for selecting a PLMN 11 last registered with a PLMN successfully as the wireless access technology for accessing a PLMN; and

S505: selecting the wireless access technology supported by the terminal for selecting a PLMN 11 as the wireless access technology for accessing a PLMN.

The process of determining the wireless access technology when the terminal for selecting a PLMN 11 accesses a PLMN may also be: first generating a wireless access technology list when the terminal for selecting a PLMN 11 accesses a PLMN, and then selecting the wireless access technology when the terminal for selecting a PLMN 11 accesses a PLMN according to the wireless access technology list.

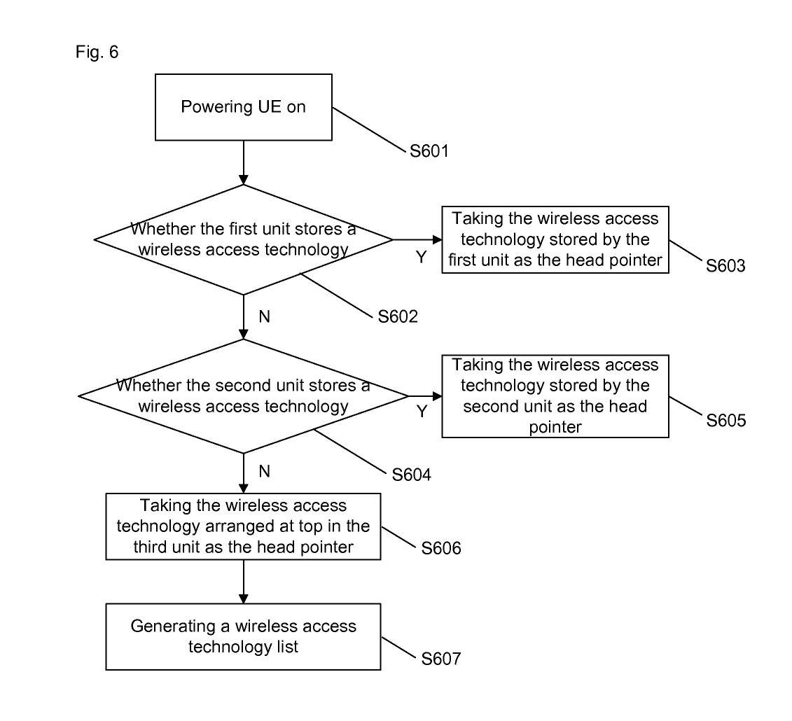

FIG. 6 is a flowchart of generating a wireless access technology list in the process of determining the wireless access technology shown in FIG. 5.

As shown in FIG. 6, in an embodiment, the method of generating a wireless access technology list when the terminal for selecting a PLMN 11 accesses a PLMN includes the following steps:

S601: powering the terminal for selecting a PLMN 11 on;

S602: detecting whether the first unit 1211 stores the wireless access technology set by the user of the terminal for selecting a PLMN 11;

S603: if the first unit 1211 stores the wireless access technology set by the user of the terminal for selecting a PLMN 11, then setting the wireless access technology stored by the first unit 1211 as the head pointer of the wireless access technology list, and releasing the same wireless access technology in the second unit and the third unit;

S604: if the first unit 1211 does not store the wireless access technology, then detecting whether the second unit 1212 stores the wireless access technology when the terminal for selecting a PLMN 11 successfully registered with a PLMN most recently;

S605: if the second unit 1212 stores the wireless access technology, then setting the wireless access technology stored by the second unit 1212 as the head pointer of the wireless access technology list, and releasing the same wireless access technology in the third unit;

S606: if the second unit 1212 does not store the wireless access technology, then setting the wireless access technology arranged at the top of the wireless access technologies stored by the third unit 1213 as the head pointer of the wireless access technology list; and

S607: setting the wireless access technology arranged at the end of the wireless access technologies stored by the third unit 1213 as the tail pointer of the wireless access technology list; and generating the wireless access technology list when the terminal for selecting a PLMN 11 accesses a PLMN; this wireless access technology list is similar to a linked list, attempting network selection in order from the head pointer to the tail pointer.

In an embodiment, in the method for selecting a PLMN of above embodiment, if the user of the terminal for selecting a PLMN 11 did not set a wireless access technology, and the terminal for selecting a PLMN 11 did not register with a PLMN successfully, all the wireless access technologies supported by the terminal for selecting a PLMN 11 are arranged in order of GERAN, UMTS and LTE to generate a wireless access technology list, and all the wireless access technologies supported by the terminal for selecting a PLMN 11 are selected in order as the wireless access technology when the terminal for selecting a PLMN 11 searches a PLMN.

In an embodiment, in the method for selecting a PLMN shown in FIG. 4, generating a PLMN list according to the wireless access technology includes the following steps:

according to the selected wireless access technology, the terminal for selecting a PLMN 11 detects all the available PLMNs conforming to the selected wireless access technology; and

arranging all the detected available PLMNs according to a preset rule to generate a PLMN list.

In an embodiment, the preset rule in the above method for selecting a PLMN is: arranging all the available PLMNs in order of RPLMN, HPLMN, OPLMN, UPLMN, PLMN with better signal intensity and PLMN with other signal intensity; when there are multiple other PLMNs, they are arranged in descending order of signal intensity; if there are multiple UPLMNs and OPLMNs, they are arranged according to priority; when there are multiple other PLMNs with equivalent signal intensity, they are arranged according to priority.

The disclosure is further elaborated below in combination with actual situation; a network selecting method in the prior art and a network selecting method provided by the disclosure are compared intuitively, so as to show the beneficial technical effects of the disclosure compared with the prior art.

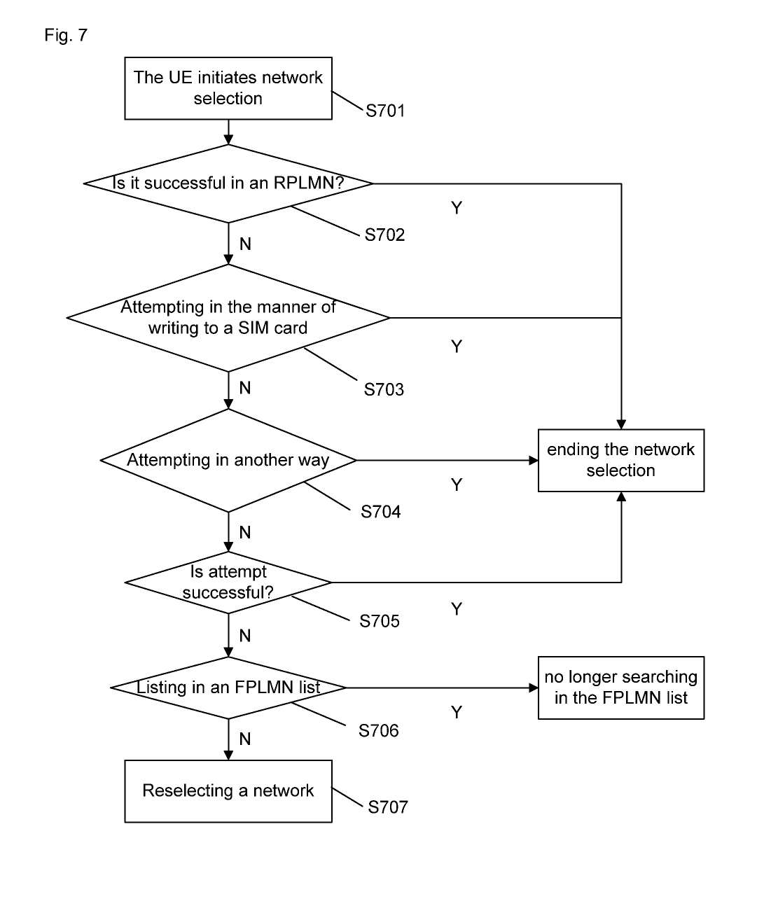

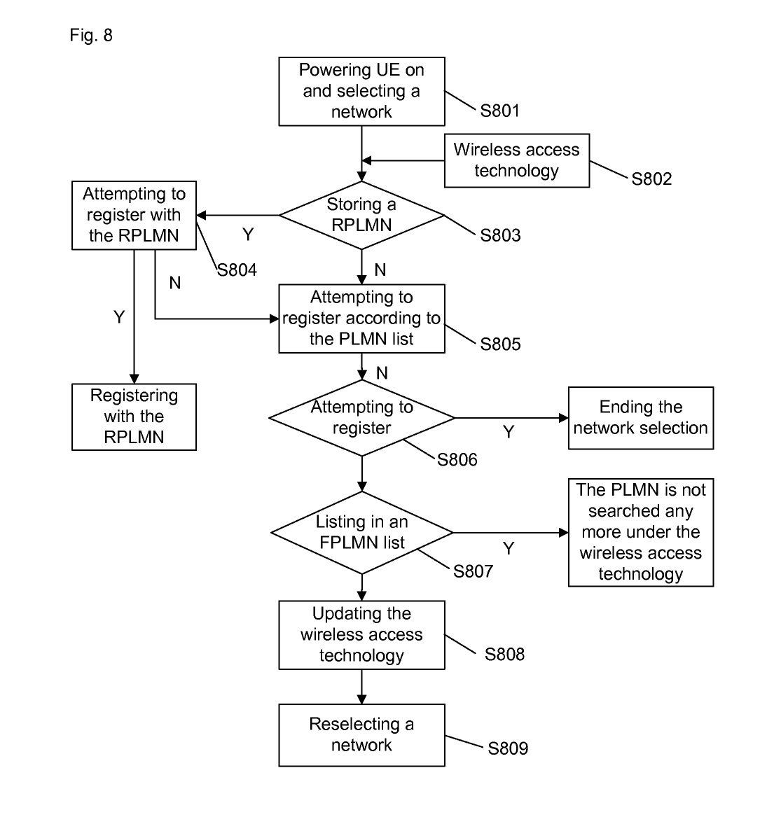

FIG. 7 is a flowchart of a network selecting method provided by a current 3GPP standard protocol; FIG. 8 is a flowchart of a specific implementation mode of a method for selecting a PLMN provided by the disclosure.

It can be seen from FIG. 7 that the network selecting method provided by the current 3GPP standard protocol includes the following steps:

S701: powering UE on;

S702: determining whether an RPLMN is stored; if it is stored and attempt is successful, then ending the process of network selection;

S703: if it is not stored, then searching the first PLMN according to priority, and searching first according to the wireless access technology written to the SIM card; if the first PLMN is found, then ending the process of network selection;

S704: if the first PLMN is not found, then searching the PLMN according to the other wireless access technologies; if search is successful, the ending the process of network selection;

S705: if search is not successful, then searching the next PLMN in the same way until attempting all the PLMNs;

S706: if network selection is rejected, then determining whether to list the PLMN in the FPLMN list; if the PLMN is listed in the FPLMN list, then not automatically searching for this PLMN any more; and

S707: if this PLMN is not listed in the PLMN list, then initiating a flow of network reselection by the UE; the process of network selection is time-consuming, besides, after a certain PLMN is added into the FPLMN list, it can not be searched any more.

It can be seen from FIG. 8 that a specific implementation mode of the method for selecting a PLMN provided by the disclosure includes the following steps:

S801: initiating a flow of selecting a network by the terminal for selecting a PLMN 11 according to network environment and state;

S802: under control of the wireless access technology module, selecting a wireless access technology and an order for accessing a PLMN;

S803: based on the current wireless access technology, detecting whether an RPLMN is stored;

S804: if stored, then attempting the RPLMN by the terminal for selecting a PLMN 11; if it is successful, then ending the process of network selection;

S805: if not stored, attempting to register according to the PLMN list;

S806: attempting the first PLMN, namely the HPLMN, in the PLMN list under the current wireless access technology; if it is successful, then ending the process of network selection;

S807: if it is unsuccessful, determining whether to list this PLMN in the FPLMN list, and attempting to search the next PLMN in the PLMN list under the current wireless access technology;

S808: if an available PLMN under the current wireless access technology can not be founded all the time, then updating the wireless access technology module, moving the pointer of the wireless access technology module to point to the next wireless access technology;

S808: repeating S803 to S807 according to the new selected wireless access technology, until network selection is successful; and

S809: if a network can not be found all the time, restarting the network selecting steps S801 to S808, until network selection is successful.

In the present implementation method, if a certain PLMN is listed in the FPLMN list, it just means that the PLMN will not be automatically searched any more after it is listed in the FPLMN list under the wireless access technology; the PLMN under other wireless access technologies can still be an Available Public Land Mobile Network (APLMN).

In conclusion, through implementation of the disclosure, there are at least the following beneficial effects:

1) network selection is performed by a user-defined wireless access technology, which enhances the user experience; and there is no need to write a wireless access technology to an SIM card any more, which reduces production cost of the SIM card;

2) for the cooperated operators, if one operator has only one wireless access technology, then it hopes to find a network under its own wireless access technology, and the disclosure can make it be found as soon as possible;

3) the PLMN which is listed in the FPLMN list is no longer forbidden completely, it is listed as an FPLMN only under a certain wireless access technology, and may be found under other access technologies, which is very significant for the cooperated operators; and

4) both the wireless access technology module and the PLMN module may be configured by a user, so that the user may perform the optimum configuration as needed to implement quick network selection.

The above is only the specific implementation mode of the disclosure and not intended to limit any form of the disclosure, any simple modification, equivalent variation or supplement performed to the above implementation modes according to the technical essence of the disclosure shall fall within the scope of the claims of the disclosure.

1. A method for selecting a Public Land Mobile Network (PLMN), comprising:
selecting a wireless access technology for accessing a PLMN;
generating a PLMN list according to the wireless access technology; and
searching and selecting a PLMN according to the PLMN list.

2. The method for selecting a PLMN according to claim 1, wherein the process of selecting a wireless access technology for accessing a PLMN comprises:
detecting whether a user has set a wireless access technology; if the user has set a wireless access technology, then selecting the wireless access technology set by the user as the wireless access technology for accessing a PLMN; if the user has not set a wireless access technology, then detecting whether a terminal has registered with a PLMN successfully; and
if the terminal has registered with a PLMN, then selecting a wireless access technology when the terminal last registered with the PLMN successfully as the wireless access technology for accessing a PLMN; if a terminal has not registered with a PLMN, then selecting a wireless access technology supported by the terminal as the wireless access technology for accessing a PLMN.

3. The method for selecting a PLMN according to claim 2, wherein the process of selecting a wireless access technology supported by the terminal as the wireless access technology for accessing a PLMN comprises:
arranging one or more wireless access technologies supported by the terminal in order of Global System for Mobile Communications (GSM)/Enhanced Data Rate for GSM Evolution (EDGE) Radio Access Network (GERAN), Universal Mobile Telecommunications system (UMTS) and Long Term Evolution (LTE) to generate a wireless access technology list; and
selecting a wireless access technology from the one or more wireless access technologies supported by the terminal in order according to the wireless access technology list as the wireless access technology for accessing a PLMN.

4. The method for selecting a PLMN according to claim 1, wherein the process of generating a PLMN list according to the wireless access technology comprises:
detecting all available PLMNs conforming to the wireless access technology; and
arranging all the detected available PLMNs according to a preset rule to generate the PLMN list.

5. The method for selecting a PLMN according to claim 4, wherein the preset rule is: arranging all the available PLMNs in order of Registered PLMN (RPLMN), Home PLMN (HPLMN), User Controlled PLMN (UPLMN) and Operator Controlled PLMN (OPLMN).

6. A device for selecting a Public Land Mobile Network (PLMN), comprising a wireless access technology module, a list module and a network selecting module;
the wireless access technology module is connected with the list module, and is configured to detect and store one or more wireless access technologies for accessing a PLMN which is or are supported by a terminal, and select a wireless access technology for accessing a PLMN and transmit the wireless access technology to the list module;
the list module is connected with the network selecting module, and is configured to generate a PLMN list according to the wireless access technology selected by the wireless access technology module, and transmit the PLMN list to the network selecting module; and
the network selecting module is configured to search and select a PLMN according to the PLMN list.

7. The device for selecting a PLMN according to claim 6, wherein the wireless access technology module comprises a first unit which is configured to store the wireless access technology selected by a user, a second unit which is configured to store a wireless access technology when the terminal last registered with a PLMN successfully, a third unit which is configured to store the one or more wireless access technologies supported by the terminal, and a detecting unit;
the detecting unit is configured to detect whether the first unit stores a wireless access technology; if the first unit stores a wireless access technology, then the detecting unit selects the wireless access technology stored by the first unit as the wireless access technology for accessing a PLMN; if the first unit does not store a wireless access technology, then the detecting unit detects whether the second unit stores a wireless access technology; if the second unit stores a wireless access technology, then the detecting unit selects the wireless access technology stored by the second unit as the wireless access technology for accessing a PLMN; the detecting unit is further configured to, when both the first unit and the second unit do not store a wireless access technology, select a wireless access technology from the one or more wireless access technologies stored by the third unit as the wireless access technology for accessing a PLMN.

8. The device for selecting a PLMN according to claim 7, wherein the third unit comprises a list subunit which is configured to arrange the one or more wireless access technologies stored by the third unit in order of Global System for Mobile Communications (GSM)/Enhanced Data Rate for GSM Evolution (EDGE) Radio Access Network (GERAN), Universal Mobile Telecommunications system (UMTS) and Long Term Evolution (LTE) to generate a wireless access technology list;
the detecting unit is further configured to select, according to the wireless access technology list, the one or more wireless access technologies supported by the terminal in order as the wireless access technology for accessing a PLMN.

9. The device for selecting a PLMN according to claim 6, wherein the list module is configured to detect all available PLMNs conforming to the wireless access technology, and arrange all the detected available PLMNs according to a preset rule to generate the PLMN list.

10. The device for selecting a PLMN according to claim 9, wherein the preset rule is: arranging all the available PLMNs in order of Registered PLMN (RPLMN), Home PLMN (HPLMN), User Controlled PLMN (UPLMN) and Operator Controlled PLMN Selector with Access Technology (OPLMN).

11. A terminal for selecting a Public Land Mobile Network (PLMN), comprising the device for selecting a PLMN according to claim 6; the terminal for selecting a PLMN using the device for selecting a PLMN to search, select and register with a PLMN.

12. The method for selecting a PLMN according to claim 2, wherein the process of generating a PLMN list according to the wireless access technology comprises:
detecting all available PLMNs conforming to the wireless access technology; and
arranging all the detected available PLMNs according to a preset rule to generate the PLMN list.

13. The method for selecting a PLMN according to claim 3, wherein the process of generating a PLMN list according to the wireless access technology comprises:
detecting all available PLMNs conforming to the wireless access technology; and
arranging all the detected available PLMNs according to a preset rule to generate the PLMN list.

14. The method for selecting a PLMN according to claim 12, wherein the preset rule is: arranging all the available PLMNs in order of Registered PLMN (RPLMN), Home PLMN (HPLMN), User Controlled PLMN (UPLMN) and Operator Controlled PLMN (OPLMN).

15. The method for selecting a PLMN according to claim 13, wherein the preset rule is: arranging all the available PLMNs in order of Registered PLMN (RPLMN), Home PLMN (HPLMN), User Controlled PLMN (UPLMN) and Operator Controlled PLMN (OPLMN).

16. The device for selecting a PLMN according to claim 7, wherein the list module is configured to detect all available PLMNs conforming to the wireless access technology, and arrange all the detected available PLMNs according to a preset rule to generate the PLMN list.

17. The device for selecting a PLMN according to claim 8, wherein the list module is configured to detect all available PLMNs conforming to the wireless access technology, and arrange all the detected available PLMNs according to a preset rule to generate the PLMN list.

18. The device for selecting a PLMN according to claim 16, wherein the preset rule is: arranging all the available PLMNs in order of Registered PLMN (RPLMN), Home PLMN (HPLMN), User Controlled PLMN (UPLMN) and Operator Controlled PLMN Selector with Access Technology (OPLMN).

19. The device for selecting a PLMN according to claim 17, wherein the preset rule is: arranging all the available PLMNs in order of Registered PLMN (RPLMN), Home PLMN (HPLMN), User Controlled PLMN (UPLMN) and Operator Controlled PLMN Selector with Access Technology (OPLMN).

20. A terminal for selecting a Public Land Mobile Network (PLMN), comprising the device for selecting a PLMN according to claim 7; the terminal for selecting a PLMN using the device for selecting a PLMN to search, select and register with a PLMN.

21. A terminal for selecting a Public Land Mobile Network (PLMN), comprising the device for selecting a PLMN according to claim 8; the terminal for selecting a PLMN using the device for selecting a PLMN to search, select and register with a PLMN.

22. A terminal for selecting a Public Land Mobile Network (PLMN), comprising the device for selecting a PLMN according to claim 9; the terminal for selecting a PLMN using the device for selecting a PLMN to search, select and register with a PLMN.

23. A terminal for selecting a Public Land Mobile Network (PLMN), comprising the device for selecting a PLMN according to claim 10; the terminal for selecting a PLMN using the device for selecting a PLMN to search, select and register with a PLMN.
